(19) United States
(12) Patent Application Publication
(10) Pub. No.: US 2026/0279858 A1
(43) Pub. Date: Sep. 17, 2026

(54) FUEL CELL SYSTEM AND CONTROL METHOD THEREOF

(71) Applicant: HONDA MOTOR CO., LTD., Tokyo (JP)

(72) Inventor: Hikaru WATANABE, Saitama (JP)

(21) Appl. No.: 19/554,667

(22) Filed: Mar. 3, 2026

(30) Foreign Application Priority Data
Mar. 13, 2025 (JP) 2025-040373

(51) Int. Cl. H01M 8/04291; H01M 8/0438; H01M 8/04537; H01M 8/04828; H01M 8/04858; H01M 8/04992

(52) U.S. Cl. CPC H01M 8/04291; H01M 8/0438; H01M 8/04582; H01M 8/04641; H01M 8/0485; H01M 8/04902; H01M 8/04992

(57) ABSTRACT

A fuel cell system includes an atmospheric pressure sensor, a current sensor, and an ECU configured to control output of a fuel cell stack. The ECU is configured to execute: a process of setting a current threshold for an output current based on a degree of humidity of the fuel cell stack; a process of counting a number of times a current detection value becomes equal to or more than the current threshold; an increase rate limitation process of limiting an increase rate of the output current to a predetermined increase rate upper-limit value or less when a number of high load cycles becomes equal to or more than a set number of times set to 1 or more; and an upper limit limitation process of limiting the output current to be equal to or less than a current upper-limit value after the increase rate limitation process starts.

This application is based on and claims the benefit of priority from Japanese Patent Application No. 2025-040373, filed on 13 March 2025, the content of which is incorporated herein by reference.

### BACKGROUND OF THE INVENTION

### Field of the Invention

The present invention relates to a fuel cell system and a control method thereof.

### Related Art

In recent years, fuel cells have been researched and developed that contribute to energy efficiency to ensure affordable, reliable, sustainable and advanced access to energy for more people.

When a fuel cell continues to generate power while its electrolyte membrane is dry, the electrolyte membrane may deteriorate. Particularly, at high altitudes where a volumetric flow rate tends to increase, when the output of the fuel cell is repeatedly increased and decreased in such environments, excessive air is supplied to the fuel cell, resulting in the electrolyte membrane drying out. In the invention disclosed in Japanese Patent No. 4139191, therefore, an upper limit for the output current of the fuel cell is set to be lower as an atmospheric pressure becomes lower.

Patent Document 1: Japanese Patent No. 4139191

### SUMMARY OF THE INVENTION

Thus, according to the invention disclosed in Japanese Patent No. 4139191, the electrolyte membrane can be prevented from drying out, but the output current of the fuel cell is limited, which may decrease convenience for a user.

The present invention aims to achieve a fuel cell system that can prevent the inside of a fuel cell from drying out without decreasing convenience for the user, and eventually contributes to energy efficiency.

(1) A fuel cell system (for example, a fuel cell system 1 to be described below) according to the present invention includes: a fuel cell (for example, a fuel cell stack 2 to be described below) that generates power when an anode gas and a cathode gas are supplied; an atmospheric pressure detector (for example, an atmospheric pressure sensor 27 to be described below) configured to detect an atmospheric pressure; a current detector (for example, a current sensor 26 to be described below) configured to detect an output current of the fuel cell; a degree-of-humidity estimator (for example, an ECU 6 to be described below) configured to estimate a degree of humidity inside the fuel cell; and an output controller (for example, an ECU 6 and a power circuit 7 to be described below) configured to control output of the fuel cell, the output controller being configured to execute: a process (for example, a process of step ST7 in FIG. 2A to be described below) of setting a current threshold for the output current to be a smaller value as the degree of humidity decreases; a process (for example, a process of step ST8 in FIG. 2A to be described below) of counting, as a number of high load cycles, a number of times a current detection value by the current detector becomes equal to or more than the current threshold; and an increase rate limitation process (for example, a process of step ST10 in FIG. 2B to be described below) of limiting an increase rate (that is, an increase amount per unit time) of the output current to a predetermined increase rate upper-limit value or less when the number of high load cycles becomes equal to or more than a set number of times set to 1 or more while the atmospheric pressure is less than a predetermined pressure.

(2) In this case, preferably, the output controller further executes: a process (for example, a process of step ST11 in FIG. 2B to be described below) of counting, as a limit time, a time elapsed from a start of the increase rate limitation process; a process (for example, a process of step ST12 in FIG. 2B to be described below) of setting a setting time, which is a threshold for the limit time, to be longer as the degree of humidity decreases; and an upper limit limitation process (for example, a process of step ST16 in FIG. 2B to be described below) of limiting the output current to be equal to or less than a current upper-limit value, which is set to a value smaller than the current threshold, as the current detection value becomes equal to or more than the current threshold until the limit time reaches the setting time.

(3) In this case, preferably, the output controller sets the increase rate upper-limit value to a smaller value as the degree of humidity decreases.

(4) In this case, preferably, the output controller reduces the current upper-limit value in steps every time the current detection value reaches the current upper-limit value.

(5) In this case, preferably, the fuel cell system further includes an impedance acquirer (for example, an impedance sensor 25 to be described below) configured to acquire impedance of the fuel cell, and the degree-of-humidity estimator estimates the degree of humidity based on the atmospheric pressure and the impedance.

(6) In this case, preferably, the output controller ends the increase rate limitation process and the upper limit limitation process when the degree of humidity is maintained at or above a predetermined release threshold for a predetermined period of time or longer until the limit time reaches the setting time.

(7) A control method of a fuel cell system according to the present invention includes: detecting an atmospheric pressure; detecting an output current of the fuel cell; estimating a degree of humidity inside the fuel cell; setting a current threshold for the output current to be a smaller value as the degree of humidity decreases; counting, as a number of high load cycles, a number of times a current detection value of the output current becomes equal to or more than the current threshold; and executing an increase rate limitation process of limiting an increase rate of the output current to a predetermined increase rate upper-limit value or less when the number of high load cycles becomes equal to or more than a set number of times set to 1 or more while the atmospheric pressure is less than a predetermined pressure.

(8) A fuel cell system (for example, a fuel cell system 1 to be described below) according to the present invention includes: a fuel cell that generates power when an anode gas and a cathode gas are supplied; a current detector configured to detect an output current of the fuel cell; a degree-of-humidity estimator configured to estimate a degree of humidity inside the fuel cell; and an output controller configured to control output of the fuel cell, the output controller being configured to execute: a process of setting a current threshold for the output current to be a smaller value as the degree of humidity decreases; a process of counting, as a number of high load cycles, a number of times a current detection value by the current detector becomes equal to or more than the current threshold; and an increase rate limitation process of limiting an increase rate of the output current to a predetermined increase rate upper-limit value or less when the number of high load cycles becomes equal to or more than a set number of times set to 1 or more while the degree of humidity is less than a predetermined dryness determination threshold.

(9) In this case, preferably, the fuel cell system further includes: an atmospheric pressure detector configured to detect an atmospheric pressure; and an impedance acquirer configured to acquire impedance of the fuel cell, and the degree-of-humidity estimator estimates the degree of humidity based on the atmospheric pressure and the impedance.

(1) The output controller executes: a process of setting the current threshold for the output current to be a smaller value as the degree of humidity inside the fuel cell decreases; a process of counting, as the number of high load cycles, the number of times the current detection value of the output current of the fuel cell becomes equal to or more than the current threshold; and the increase rate limitation process of limiting the increase rate of the output current of the fuel cell to a predetermined increase rate upper-limit value or less when the number of high load cycles counted as described above becomes the set number of times equal to or more than 1 while the atmospheric pressure is less than a predetermined pressure (that is, while the fuel cell is in a high altitude environment where the inside thereof is prone to dryness). According to the present invention as described above, the increase rate limitation process is executed in a high altitude environment, whereby it is possible to prevent a sudden increase in output current, thereby preventing the inside of the fuel cell from drying out, and contributing to energy efficiency. According to the present invention, the increase rate limitation process as described above is executed only after the number of high load cycles reaches the set number of times or more while the atmospheric pressure is less than a predetermined pressure. Therefore, according to the present invention, it is possible to change the timing for starting the increase rate limitation process depending on the usage mode of the user at that time in a high altitude environment, thereby preventing a decrease in convenience for the user. According to the present invention, the current threshold described above is set to a smaller value as the degree of humidity inside the fuel cell decreases, and thus the timing for starting the increase rate limitation process can be changed depending on the internal state of the fuel cell at that time, thereby preventing a decrease in convenience for the user.

(2) The output controller executes: a process of counting, as the limit time, the time elapsed from the start of the increase rate limitation process; a process of setting the setting time to be longer as the degree of humidity decreases; and the upper limit limitation process of limiting the output current to be equal to or less than the current upper-limit value, which is set to a value smaller than the current threshold, as the current detection value becomes equal to or more than the current threshold until the limit time reaches the setting time. Therefore, according to the present invention, it is possible to change the timing for starting the upper limit limitation process, which involves a stricter limitation on the upper limit of the output than the increase rate limitation process described above, depending on the usage mode of the user at that time, thereby preventing a decrease in convenience for the user. According to the present invention, the setting time is longer as the degree of humidity inside the fuel cell decreases, and thus the timing for starting the upper limit limitation process can be changed depending on the internal state of the fuel cell at that time, thereby preventing a decrease in convenience for the user.

(3) The output controller sets the increase rate upper-limit value to a smaller value as the degree of humidity decreases. Thus, it is possible to prevent the inside of the fuel cell from drying out under appropriate limitations according to the internal state of the fuel cell at that time.

(4) The output controller reduces the current upper-limit value in steps every time the current detection value reaches the current upper-limit value. Thus, the current upper-limit value can be limited in steps depending on the usage mode of the user at that time, thereby preventing a decrease in convenience for the user.

(5) The degree-of-humidity estimator can accurately estimate the degree of humidity by estimating the degree of humidity inside the fuel cell based on the atmospheric pressure and the impedance of the fuel cell, and can therefore start the increase rate limitation process at a timing according to the internal state of the fuel cell at that time.

(6) The output controller ends the increase rate limitation process and the upper limit limitation process when the degree of humidity is maintained at or above a predetermined release threshold for a predetermined period of time or longer until the limit time reaches the setting time. Therefore, according to the present invention, the limitation on the output current can be released as the degree of humidity inside the fuel cell is restored to a state suitable for power generation by the increase rate limitation process and the upper limit limitation process.

(7) According to a control method of a fuel cell system according to the present invention, it is possible to prevent the inside of the fuel cell from drying out without reducing convenience for the user in a high altitude environment where the air tends to dry out, thereby contributing to energy efficiency.

(8) The output controller executes: a process of setting the current threshold for the output current to be a smaller value as the degree of humidity inside the fuel cell decreases; a process of counting, as the number of high load cycles, the number of times the current detection value of the output current of the fuel cell becomes equal to or more than the current threshold; and the increase rate limitation process of limiting the increase rate of the output current of the fuel cell to a predetermined increase rate upper-limit value or less when the number of high load cycles counted as described above becomes the set number of times equal to or more than 1 while the degree of humidity is less than a dryness determination threshold (that is, while the inside of the fuel cell is tending to dry out). According to the present invention as described above, the increase rate limitation process is executed while the inside of the fuel cell is tending to dry out, whereby it is possible to prevent a sudden increase in output current, thereby preventing the inside of the fuel cell from further drying out, and contributing to energy efficiency. According to the present invention, the increase rate limitation process as described above is executed only after the number of high load cycles reaches the set number of times or more while the degree of humidity is less than the dryness determination threshold. Therefore, according to the present invention, it is possible to change the timing for starting the increase rate limitation process depending on the usage mode of the user at that time in a high altitude environment, thereby preventing a decrease in convenience for the user. According to the present invention, the current threshold described above is set to a smaller value as the degree of humidity inside the fuel cell decreases, and thus the timing for starting the increase rate limitation process can be changed depending on the internal state of the fuel cell at that time, thereby preventing a decrease in convenience for the user.

(9) The degree-of-humidity estimator can accurately estimate the degree of humidity by estimating the degree of humidity inside the fuel cell based on the atmospheric pressure and the impedance of the fuel cell, and can therefore start the increase rate limitation process at a timing according to the internal state of the fuel cell at that time.

### BRIEF DESCRIPTION OF THE DRAWINGS

FIG. 1 is a diagram illustrating a configuration of a fuel cell system according to an embodiment of the present invention;

FIG. 2A is a flowchart illustrating a specific procedure of dryness protection control (part 1);

FIG. 2B is a flowchart illustrating a specific procedure of dryness protection control (part 2); and

FIG. 3 is a time chart illustrating a change in output current implemented by the dryness protection control.

### DETAILED DESCRIPTION OF THE INVENTION

Hereinafter, a fuel cell system according to an embodiment of the present invention will be described with reference to the drawings.

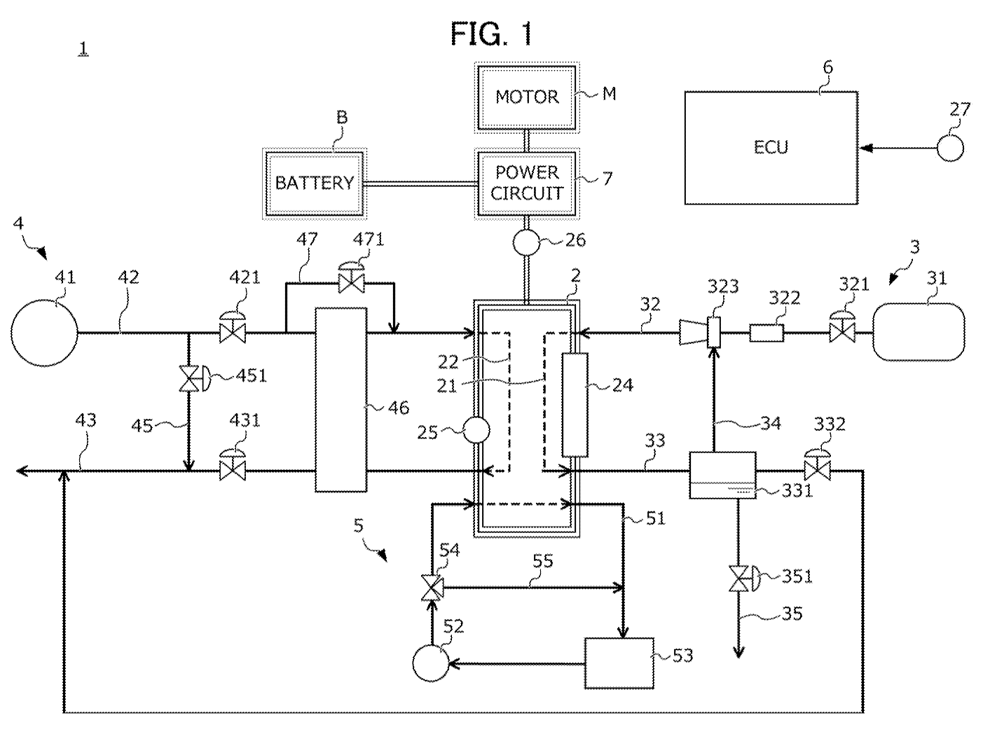

FIG. 1 is a diagram illustrating a configuration of a fuel cell system 1 according to the present embodiment. The fuel cell system 1 includes: a fuel cell stack 2 that generates power when an anode gas and a cathode gas are supplied; an anode gas supply device 3 that supplies hydrogen to the fuel cell stack 2 as an anode gas; a cathode gas supply device 4 that supplies air to the fuel cell stack 2 as a cathode gas; a cooling system 5 that cools the fuel cell stack 2; a battery B that stores the power generated by the fuel cell stack 2; a driving motor M that rotates tires (not illustrated) using the power supplied from the fuel cell stack 2 and the battery B; an power circuit 7 through which the battery B, the driving motor M, and the fuel cell stack 2 are electrically connected to one another; and an ECU 6 serving as a computer that controls these components. A case will be described below in which the fuel cell system 1 is mounted on a fuel cell vehicle that drives using the tires as drive wheels.

The fuel cell stack 2 has a stack structure in which, for example, several tens to several hundreds of fuel cells are stacked. Each of the fuel cells is configured in which a membrane electrode assembly (MEA) is sandwiched by a pair of separators. The membrane electrode assembly includes two electrodes of an anode electrode (a negative electrode) and a cathode electrode (a positive electrode), and a solid polymer electrolyte membrane sandwiched by these electrodes. In general, each of the two electrodes is formed from a catalyst layer in contact with the solid polymer electrolyte membrane to cause an oxidation-reduction reaction, and a gas diffusion layer in contact with the catalyst layer. When hydrogen is supplied to an anode flow channel 21 formed adjacent to the anode electrode and air containing oxygen is supplied to a cathode flow channel 22 formed adjacent to the cathode electrode, the fuel cell stack 2 generates power due to an electrochemical reaction between oxygen and hydrogen. The power generated by the fuel cell stack 2 is supplied to the driving motor M, the battery B, or the like serving as loads through the power circuit 7.

The anode gas supply device 3 includes: a hydrogen tank 31 that stores a hydrogen gas at a high pressure; a hydrogen supply pipe 32 that extends from the hydrogen tank 31 to an introduction part of the anode flow channel 21 of the fuel cell stack 2; a hydrogen discharge pipe 33 that extends from a discharge part of the anode flow channel 21 to a diluter (not illustrated) which is provided in the cathode gas supply device 4; and a hydrogen return pipe 34 that branches from the hydrogen discharge pipe 33 and extends to the hydrogen supply pipe 32.

A shutoff valve 321, an injector 322, and an ejector 323 are provided on the hydrogen supply pipe 32 in order from the hydrogen tank 31 toward the fuel cell stack 2, the injector 322 being configured to inject a hydrogen gas supplied through the shutoff valve 321 toward the fuel cell stack 2, the ejector 323 being configured to circulate a gas discharged from the anode flow channel 21 (hereinafter, also referred to as "anode off-gas") to the fuel cell stack 2. The shutoff valve 321 is an electromagnetic valve that opens and closes in response to a command signal from the ECU 6. The amount of hydrogen gas to be injected from the injector 322 is controlled by PWM control of the ECU 6.

The hydrogen return pipe 34 is a pipe that connects the hydrogen discharge pipe 33 and the ejector 323. Thus, the anode off-gas containing hydrogen, together with an anode gas newly injected from the injector 322, circulates in a circulation flow channel formed by the hydrogen supply pipe 32, the anode flow channel 21, the hydrogen discharge pipe 33, the hydrogen return pipe 34, and the ejector 323.

A catch tank 331 and a purge valve 332 are provided on the hydrogen discharge pipe 33 in order from the fuel cell stack 2 toward the cathode gas supply device 4, the catch tank 331 being configured to store water contained in the anode off-gas, the purge valve 332 being configured to discharge the anode off-gas to the cathode gas supply device 4. A drain pipe 35 is provided at the catch tank 331 to discharge accumulated water. The drain pipe 35 extends from the catch tank 331 to the downstream side of the purge valve 332 on the hydrogen discharge pipe 33. A drain valve 351 is provided on the drain pipe 35. When the drain valve 351 is opened, the water accumulated in the catch tank 331 is discharged to the diluter (not illustrated) through the hydrogen discharge pipe 33. The purge valve 332 and the drain valve 351 are electromagnetic valves that open and close in response to command signals from the ECU 6.

The cathode gas supply device 4 includes an air compressor 41, an air supply channel 42 extending from the air compressor 41 to the introduction part of the cathode flow channel 22, an air discharge pipe 43 extending from the discharge part of the cathode flow channel 22 to the diluter (not illustrated), an air bypass pipe 45 branching from the air discharge pipe 43 and extending to the air supply pipe 42, and a humidifier 46 connecting the air discharge pipe 43 and the air supply pipe 42.

The air compressor 41 supplies outside air to the cathode flow channel 22 of the fuel cell stack 2 through the air supply pipe 42. The air compressor 41 operates in response to a command signal from the ECU 6. The humidifier 46 retrieves water contained in the gas discharged from the cathode flow channel 22 (hereinafter, also referred to as a "cathode off-gas"), and humidifies the air supplied from the air compressor 41 using the retrieved water. Due to the function of the humidifier 46, the MEA of the fuel cell stack 2 in power generation is maintained in a humidified state suitable for power generation.

The air supply pipe 42 is provided with a humidifier bypass pipe 47 that bypasses the humidifier 46. A bypass valve 471 is provided on the humidifier bypass pipe 47. When the bypass valve 471 is opened, most of the air supplied from the air compressor 41 bypasses the humidifier 46 and is supplied to the fuel cell stack 2. The bypass valve 471 is an electromagnetic valve that opens and closes in response to a command signal from the ECU 6.

In addition, an inlet sealing valve 421 and an outlet sealing valve 431 are provided on the air supply pipe 42 and the air discharge pipe 43, respectively. When these sealing valves 421 and 431 are closed, the inside of the cathode flow channel 22 is isolated from the outside air. These sealing valves 421 and 431 are electromagnetic valves that open and close in response to command signals from the ECU 6.

The air bypass pipe 45 is a pipe that connects the air supply pipe 42 on a high-pressure side to the air discharge pipe 43 on a low-pressure side. More specifically, the air bypass pipe 45 connects an upstream side of the air supply pipe 42 relative to the humidifier 46 and the inlet sealing valve 421 to a downstream side of the air discharge pipe 43 relative to the humidifier 46 and the outlet sealing valve 431. Therefore, a part of the air supplied from the air compressor 41 bypasses the humidifier 46 and the cathode flow channel 22 and is discharged to the air discharge pipe 43 through the air bypass pipe 45.

A back pressure control valve 451 is provided on the air bypass pipe 45 to adjust a back pressure of the cathode flow channel 22 of the fuel cell stack 2. The back pressure control valve 451 is an electromagnetic valve that opens and closes in response to a command signal from the ECU 6.

The cooling system 5 includes: a coolant circulation channel 51 including the inside of the fuel cell stack 2 as a part of the flow channel; a cooling pump 52 that circulates a coolant within the coolant circulation channel 51; a radiator 53 that is provided in the coolant circulation channel 51 upstream of the cooling pump 52; a thermal valve 54 that is provided in the coolant circulation channel 51 downstream of the cooling pump 52; and a bypass pipe 55 that connects the thermal valve 54 to the coolant circulation channel 51 upstream of the radiator 53.

The fuel cell stack 2 is cooled by heat exchange with a coolant flowing through a flow channel therein. The radiator 53 cools the coolant by heat exchange with the outside air. The cooling pump 52 operates in response to a command signal from the ECU 6. The rotation speed of the cooling pump 52 is controlled by the ECU 6. Since an increase in the rotation speed of the cooling pump 52 causes an increase in a flow rate of the coolant that circulates within the coolant circulation channel 51, which includes the fuel cell stack 2 and the radiator 53 in its coolant flow channel, cooling capacity of the fuel cell stack 2 can be raised.

The thermal valve 54 is a three-way valve that opens and closes in response to a command signal from the ECU 6. An opening ratio of the thermal valve 54 (a ratio of an opening on the coolant circulation channel 51 (100 to 0[%]) to an opening on the bypass pipe 55 (0 to 100[%])) is controlled by the ECU 6. When the opening ratio of the thermal valve 54 is set to the maximum (that is, "1"), all of the coolant discharged from the cooling pump 52 is supplied to the fuel cell stack 2, and thus the cooling capacity of the fuel cell stack 2 can be raised. Furthermore, when the opening ratio of the thermal valve 54 is set to the minimum (that is, "0"), all of the coolant discharged from the cooling pump 52 is supplied to the bypass pipe 55.

The battery B is a secondary battery that can perform both discharging of converting chemical energy into electrical energy and charging of converting electrical energy into chemical energy. A case will be described below in which a so-called lithium ion storage battery is used as the battery B that is charged and discharged by movement of lithium ions between electrodes, but the present invention is not limited thereto. For example, a capacitor may be used as the battery B.

The power circuit 7 is configured by, for example, a power line that connects the fuel cell stack 2 to the driving motor M, the battery B, or the like, a DC-DC converter that is provided on the power line to step up or down DC power output from the fuel cell stack 2, and an inverter that is provided on the power line to convert the DC power output from the DC-DC converter into three-phase AC power and supply it to the driving motor M, or to convert the three-phase AC power supplied from the driving motor M into DC power and supply it to the battery B. A plurality of switching elements constituting these DC-DC converter and the inverter are turned on/off depending on gate drive signals generated at predetermined timing by a gate drive circuit (not illustrated) of the ECU 6. Therefore, the ECU 6 can control the flow of power between the fuel cell stack 2, the battery B, and the driving motor M in the power circuit 7 by operating the DC-DC converter and the inverter using the gate drive circuit.

The ECU 6 is a computer having a plurality of functions, for example, a required output acquisition function, a power generation control function, a temperature control function, an output control function, and a dryness protection control function. The required output acquisition function refers to a function in which the ECU 6 acquires a required output current value corresponding to a required value for an output current of the fuel cell stack 2 (that is, a current supplied from the fuel cell stack 2 to the loads such as the driving motor M and the battery B through the power circuit 7), based on the amount of operation of an accelerator pedal, a brake pedal, or the like (not illustrated), by a driver.

The power generation control function refers to a function in which the ECU 6 operates the anode gas supply device 3, the cathode gas supply device 4, and the like, to control a power generation state of the fuel cell stack 2. The temperature control function refers to a function in which the ECU 6 operates the cooling system 5 to control a temperature of the fuel cell stack 2.

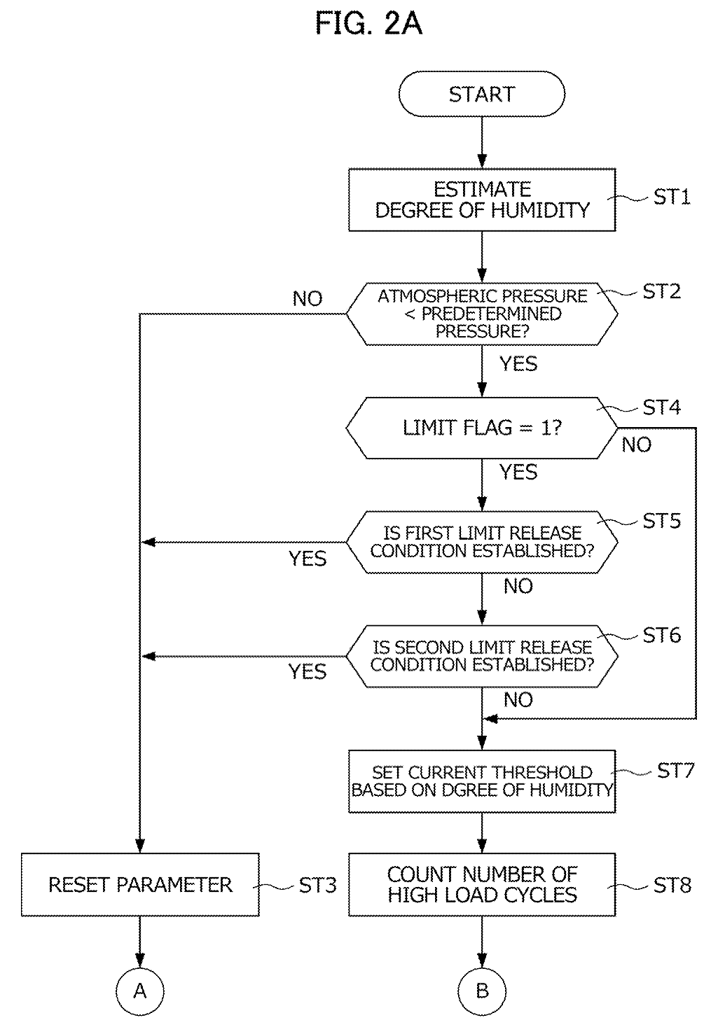

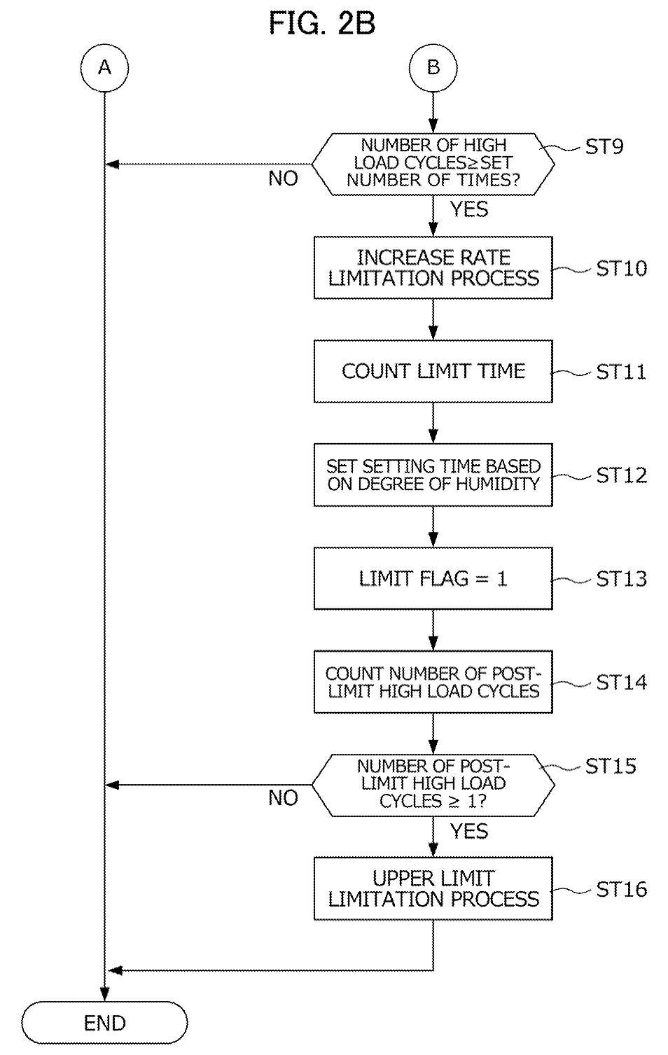

The output control function refers to a function in which the ECU 6 operates the DC-DC converter and the inverter of the power circuit 7 to control the output current of the fuel cell stack 2 so that the required current output value acquired by the required output acquisition function described above is satisfied. In addition, the dryness protection control function refers to a function in which the ECU 6 executes, for example, dryness protection control to be described below (see FIGS. 2A and 2B to be described below) to limit the output current of the fuel cell stack 2 so that the inside of the fuel cell stack 2 is not dried out excessively.

The ECU 6 is connected to a plurality of sensors, which are used to determine a state of the fuel cell stack 2 in power generation, for example, a cell voltage sensor 24, an impedance sensor 25, a current sensor 26, and an atmospheric pressure sensor 27.

The cell voltage sensor 24 detects a voltage of each of fuel cells (so-called cell voltage) that constitute the fuel cell stack 2, and transmits a signal approximately proportional to the detected value to the ECU 6. The current sensor 26 detects the output current of the fuel cell stack 2, more specifically, the current output from the fuel cell stack 2 to the loads such as driving motor M and the battery B through the power circuit 7, and transmits a signal approximately proportional to the detected value to the ECU 6.

The impedance sensor 25 detects impedance of the fuel cell stack 2, and transmits a signal approximately proportional to the detected value to the ECU 6. The atmospheric pressure sensor 27 detects an atmospheric pressure around the fuel cell stack 2, and transmits a signal approximately proportional to the detected value to the ECU 6. Here, the degree of humidity inside the fuel cell stack 2 is correlated with the impedance of the fuel cell stack 2 and the atmospheric pressure at the location where the fuel cell stack 2 is present, for example. More specifically, the degree of humidity inside the fuel cell stack 2 tends to decrease as the impedance increases, and tends to decrease as the atmospheric pressure becomes lower. Therefore, the ECU 6 estimates the degree of humidity inside the fuel cell stack 2 based on the impedance detected by the impedance sensor 25 and the atmospheric pressure detected by the atmospheric pressure sensor 27.

FIGS. 2A and 2B are flowcharts illustrating a specific procedure for dryness protection control to prevent the fuel cell stack 2 from drying out excessively under a high altitude environment. The dryness protection control is repeatedly executed by the ECU 6 at a predetermined control cycle when the fuel cell stack 2 is generating power.

First, in step ST1, the ECU 6 estimates the degree of humidity inside the fuel cell stack 2 based on the atmospheric pressure, the impedance, and the like, and then proceeds to step ST2. More specifically, the ECU 6 estimates that the degree of humidity decrease as the atmospheric pressure becomes lower and the impedance increases.

Next, in step ST2, the ECU 6 determines whether the current atmospheric pressure is lower than a predetermined high altitude determination pressure. When the ECU 6 can determine YES in step ST2, that is, can determine that the fuel cell stack 2 in current power generation is in a high altitude environment where the inside thereof is prone to dryness, the process proceeds to step ST4. When the ECU 6 can determine NO in step ST2, that is, can determine that the fuel cell stack 2 in current power generation is not in a high altitude environment, the process proceeds to step ST3.

In step ST3, the ECU 6 resets values of a plurality of parameters, and ends the dryness protection control illustrated in FIGS. 2A and 2B. The plurality of parameters rest in the process of step ST3 includes the number of high load cycles, a limit time, a limit flag, the number of post-limit high load cycles, and the like. The number of high load cycles refers to the number of times the load on the fuel cell stack 2 becomes high, more specifically, the number of times the output current of the fuel cell stack 2 exceeds a predetermined current threshold, the number of high load cycles being counted in step ST8 to be described below and being reset to "0" in step ST3. The limit time refers to a time during which the process of limiting an increase rate of the output current of the fuel cell stack 2 in a high altitude environment (an increase rate limitation process in step ST10 to be described below) is executed, the limit time being counted in step ST11 to be described below and being reset to "0" in step ST3. The limit flag refers to a flag indicating that the increase rate limitation process in step ST10 to be described below is being executed, the limit flag being set to "1" in step ST13 to be described below and being reset to "0" in step ST3. In other words, when the increase rate limitation process to be described below is being executed, the value of the limit flag is set to "1", and when the increase rate limitation process is not being executed, the value of the limit flag is set to "0". The number of post-limit high load cycles refers to the number of high load cycles after the increase rate limitation process starts, the number of post-limit high load cycles being counted in step ST14 to be described below and being reset to "0" in step ST3.

In step ST4, the ECU 6 determines whether the value of the limit flag is "1". When the ECU 6 determines in step ST4 to be YES, that is, when the increase rate limitation process is currently being executed, the process proceeds to step ST5. When the ECU 6 determines in step ST4 to be NO, that is, when the increase rate limitation process is not being executed, steps ST5 and ST6 to be described below are not executed, and the process proceeds to step ST7.

In step ST7, the ECU 6 sets a current threshold that is a threshold for the output current of the fuel cell stack 2, based on the degree of humidity estimated in step ST1, and the process proceeds to step ST8. More specifically, the ECU 6 sets the current threshold to a smaller value as the degree of humidity decreases.

In step ST8, the ECU 6 counts, as the number of high load cycles, the number of times a current detection value becomes equal to or more than the current threshold set in step ST7 while the atmospheric pressure is less than the high altitude determination pressure, and the process proceeds to step ST9. More specifically, the ECU 6 counts up the number of high load cycles by "1" at a timing when the current detection value becomes equal to or more than the current threshold.

In step ST9, the ECU 6 determines whether the number of high load cycles counted in step ST8 is equal to or more than a set number of times that is set to a value equal to or more than "1". A case will be described below in which the set number of times is set to "2", but the present invention is not limited thereto. The set number of times may be set to "1" or an integer of "3" or more. When the ECU 6 determines in step ST9 to be YES, the process proceeds to step ST10, and when ECU 6 determines to be NO, the dryness protection control illustrated in FIGS. 2A and 2B ends.

In step ST10, the ECU 6 executes an increase rate limitation process of limiting the increase rate of the output current of the fuel cell stack 2 to a predetermined increase rate upper-limit value or less, and the process proceeds to step ST11. Here, the ECU 6 preferably sets the increase rate upper-limit value to a smaller value as the degree of humidity estimated in step ST1 decreases. In the increase rate limitation process, the ECU 6 controls the output current so that the required output current value of the driver is satisfied within a range in which the increase rate of the output current of the fuel cell stack 2 does not exceed the increase rate upper-limit value described above.

In step ST11, the ECU 6 counts, as the limit time, a time that has elapsed since the increase rate limitation process is started in step ST10, and the process proceeds to step ST12.

In step ST12, the ECU 6 sets a setting time, which is a threshold for the limit time, based on the degree of humidity estimated in step ST1, and the process proceeds to step ST13. More specifically, the ECU 6 sets the setting time to be longer as the degree of humidity decreases.

In step ST13, the ECU 6 sets the value of the limit flag to "1" to indicate that the increase rate limitation process is being executed, and the process proceeds to step ST14.

As described above, the ECU 6 starts the increase rate limitation process when the number of high load cycles is equal to or more than the set number of times while the atmospheric pressure is less than the high altitude determination pressure, sets the value of the limit flag to "1", and starts counting the limit time corresponding to the execution time of the increase rate limitation process. Therefore, from the next cycle, steps ST5 and ST6 are executed.

In step ST5, the ECU 6 determines whether a first limit release condition is established. The limit release condition herein corresponds to a condition for ending the increase rate limitation process being executed in a high altitude environment. More specifically, the ECU 6 assigns, as the first limit release condition, that the limit time as the execution time of the increase rate limitation process reaches the setting time which is determined based on the degree of humidity in step ST12. In other words, when the limit time reaches the setting time, the ECU 6 determines that the first limit release condition is established, and the process proceeds to step ST3. Furthermore, when the limit time does not reach the setting time, the ECU 6 determines that the first limit release condition is not established, and the process proceeds to step ST6.

In step ST6, the ECU 6 determines whether a second limit release condition is established. The ECU 6 assigns, as the second limit release condition, that the degree of humidity is restored and further stabilized. More specifically, the ECU 6 determines whether the degree of humidity is restored and stabilized based on the history of the degree of humidity estimated in step ST1. More specifically, when the degree of humidity is maintained at or above a predetermined release threshold for a predetermined period of time or longer, the ECU 6 determines that the degree of humidity is restored and stabilized. In other words, when the ECU 6 determines that the degree of humidity is restored and stabilized until the limit time reaches the setting time, it determines that the second limit release condition is established, and the process proceeds to step ST3. Furthermore, when the ECU 6 determines that the degree of humidity is not restored and stabilized, it determines that the second limit release condition is not established, and the process proceeds to step ST7 to continuously execute the increase rate limitation process.

On the other hand, in step ST14, the ECU 6 counts, as the number of post-limit high load cycles, the number of times the current detection value becomes equal to or more than the current threshold set in step ST7 after the increase rate limitation process is started, and the process proceeds to step ST15. More specifically, the ECU 6 calculates the number of post-limit high load cycles by subtracting the set number of times referred to in step ST9 from the number of high load cycles counted in step ST8.

In step ST15, the ECU 6 determines whether the number of post-limit high load cycles counted in step ST14 is "1" or more. When the ECU 6 determines in step ST15 to be YES, that is, when the current detection value becomes equal to or more than the current threshold even once after the increase rate limitation process starts, the process proceeds to step ST16. In addition, when the ECU 6 determines in step ST15 to be NO, the dryness protection control illustrated in FIGS. 2A and 2B ends.

In step ST16, the ECU 6 executes an upper limit limitation process to limit the output current of the fuel cell stack 2 to be equal to or less than a current upper-limit value set to a value smaller than the above-described current threshold, and the dryness protection control illustrated in FIGS. 2A and 2B ends. In the upper limit limitation process, the ECU 6 controls the output current so that the required output current value of the driver is satisfied within a range in which the output current of the fuel cell stack 2 does not exceed the current upper-limit value described above. After starting the upper limit limitation process as described above, the ECU 6 preferably reduces the current upper-limit value in steps every time the current detection value reaches the current upper-limit value.

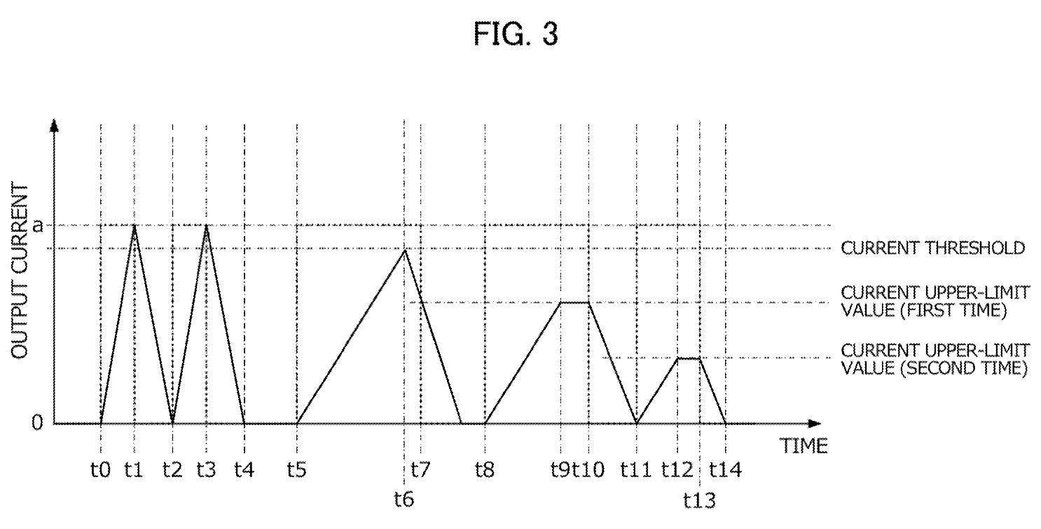

FIG. 3 is a time chart illustrating a change in output current achieved by the dryness protection control illustrated in FIGS. 2A and 2B. In FIG. 3, the required output current value is indicated by a thick dashed line, and the current detection value is indicated by a thick solid line. Furthermore, FIG. 3 illustrates a case where the required output current value changes intermittently between "0" and "a" which is larger than the current threshold described above, as the driver repeatedly accelerates and decelerates in a high altitude environment. More specifically, a case is shown where the required output current value is "a" between times t0 and t1, between times t2 and t3, between times t5 and t7, between times t8 and t10, and between times t11 and t13, and a case is shown where the required output current value is "0" between times t1 and t2, between times t3 and t5, between times t7 and t8, between times t10 and t11, and between times t13 and t14. FIG. 3 also illustrates a case where the set number of times is set to "2".

First, between times t0 and t1, the current detection value increases from "0" toward "a" which is larger than the current threshold. For this reason, between times t0 and t1, the ECU 6 counts up the number of high load cycles to "1" (see step ST8 in FIG. 2A). Thereafter, between times t2 and t3, the current detection value again increases from "0" toward "a". For this reason, between times t2 and t3, the ECU 6 counts up the number of high load cycles to "2". Therefore, between times t2 and t3, when the number of high load cycles becomes equal to or more than the set number of times (see step ST9 in FIG. 2B), the ECU 6 starts the increase rate limitation process to limit the increase rate of the output current to be equal to or less than the increase rate upper-limit value set according to the degree of humidity at that time (see step ST10 in FIG. 2B). For this reason, as illustrated in FIG. 3, after time t3, the increase rate of the current detection value, that is, the rate at which the current detection value increases from "0" toward "a", is slower than the rate at which the current detection value increases from "0" toward "a" before time t3. Thus, since a sudden increase in output current is prevented after time t3, the inside of the fuel cell stack 2 can be prevented from drying out.

Thereafter, between times t5 and t7, the current detection value increases from "0" toward "a" under the increase rate limitation process as described above. At time t6, the ECU 6 counts up the number of times post-limit high loads to "1" as the current detection value becomes equal to or more than the current threshold (see step ST14 in FIG. 2B). Therefore, at time t6, as the number of post-limit high load cycles becomes equal to or more than "1" (see step ST15 in FIG. 2B), the ECU 6 starts the upper limit limitation process to limit the output current to be equal to or less than the current upper-limit value (see "current upper-limit value (first time)" in FIG. 3) that is set to the value smaller than the current threshold described above (see step ST16 in FIG. 2B). Thus, after time t6, since not only a sudden increase in output current is prevented but also the upper limit of the output current is limited, the inside of the fuel cell stack 2 can be prevented from drying out.

Thereafter, between times t8 and t10, the current detection value increases from "0" toward "a" under the increase rate limitation process as described above. However, as described above, after time t6, the output current is limited to the current upper-limit value (first time) or less under the upper limit limitation process as described above. For this reason, after time t6, the output current is limited to be equal to or less than the current upper-limit value (first time) smaller than the required output current value at that time, and thus the current detection value is in a state of sticking to the current upper-limit value (first time) between times t9 and t10. Furthermore, in the upper limit limitation process as described above, the ECU 6 reduces the current upper-limit value in steps every time the current detection value reaches the current upper-limit value. For this reason, after time t10, the ECU 6 sets the current upper-limit value to a value smaller than that before (see "current upper-limit value (second time)" in FIG. 3).

Thereafter, between times t11 and t13, the current detection value increases from "0" toward "a" under the increase rate limitation process as described above. However, the output current is limited to be equal to or less than the current upper-limit value (second time) that is smaller than the current upper-limit value (first time) under the upper limit limitation process as described above, and thus the current detection value is in a state of sticking to the current upper-limit value (second time) between times t12 and t13.

As described above with reference to FIGS. 2A to 3, the ECU 6 starts the increase rate limitation process to limit the increase rate of the output current to be equal to or less than the increase rate upper-limit value as the number of high load cycles becomes equal to or more than the set number of times while the atmospheric pressure is less than the high altitude determination pressure. Thereafter, under the increase rate limitation process described above, the ECU 6 starts the upper limit limitation process to limit the output current to be equal to or less than the current upper-limit value as the current detection value becomes equal to or more than the current threshold. Furthermore, the ECU 6 reduces the current upper-limit value in steps every time the current detection value reaches the current upper-limit value under the increase rate limitation process and the upper limit limitation process described above. Thus, according to the present invention, it is possible to strictly limit the output current of the fuel cell stack 2 in steps depending on the usage mode of the driver at that time, thereby preventing the fuel cell stack 2 from drying out while preventing a decrease in convenience for the driver.

The fuel cell system 1 according to the present embodiment has the following effects.

(1) The ECU 6 executes: a process of setting the current threshold for the output current to be a smaller value as the degree of humidity inside the fuel cell decreases (see step ST7); a process of counting, as the number of high load cycles, the number of times the current detection value of the output current of the fuel cell stack 2 becomes equal to or more than the current threshold (see step ST8); and the increase rate limitation process of limiting the increase rate of the output current of the fuel cell stack 2 to a predetermined increase rate upper-limit value or less (see step ST10) when the number of high load cycles counted as described above becomes the set number of times equal to or more than 1 while the atmospheric pressure is less than the high altitude determination pressure (that is, while the fuel cell is in a high altitude environment where the inside thereof is prone to dryness). According to the present invention as described above, the increase rate limitation process is executed in a high altitude environment, whereby it is possible to prevent a sudden increase in output current, thereby preventing the inside of the fuel cell stack 2 from drying out, and contributing to energy efficiency. According to the present invention, the increase rate limitation process as described above is executed only after the number of high load cycles reaches the set number of times or more while the atmospheric pressure is less than the high altitude determination pressure. Therefore, according to the present invention, it is possible to change the timing for starting the increase rate limitation process depending on the usage mode of the driver at that time in a high altitude environment, thereby preventing a decrease in convenience for the driver. According to the present invention, the current threshold described above is set to a smaller value as the degree of humidity inside the fuel cell stack 2 decreases, and thus the timing for starting the increase rate limitation process can be changed depending on the internal state of the fuel cell stack 2 at that time, thereby preventing a decrease in convenience for the driver.

(2) The ECU 6 executes: a process of counting, as the limit time, the time elapsed from the start of the increase rate limitation process (see step ST11); a process of setting the setting time to be longer as the degree of humidity decreases (see step ST12); and the upper limit limitation process of limiting the output current to be equal to or less than the current upper-limit value, which is set to a value smaller than the current threshold, as the current detection value becomes equal to or more than the current threshold until the limit time reaches the setting time (see step ST16). Therefore, according to the present invention, it is possible to change the timing for starting the upper limit limitation process, which involves a stricter limitation on the upper limit of the output than the increase rate limitation process described above, depending on the usage mode of the driver at that time, thereby preventing a decrease in convenience for the driver. According to the present invention, the setting time is longer as the degree of humidity inside the fuel cell stack 2 decreases, and thus the timing for starting the upper limit limitation process can be changed depending on the internal state of the fuel cell stack 2 at that time, thereby preventing a decrease in convenience for the driver.

(3) The ECU 6 sets the increase rate upper-limit value to a smaller value as the degree of humidity decreases. Thus, it is possible to prevent the inside of the fuel cell stack 2 from drying out under appropriate limitations according to the internal state of the fuel cell stack 2 at that time.

(4) The ECU 6 reduces the current upper-limit value in steps every time the current detection value reaches the current upper-limit value. Thus, the current upper-limit value can be limited in steps depending on the usage mode of the driver at that time, thereby preventing a decrease in convenience for the driver.

(5) The ECU 6 can accurately estimate the degree of humidity by estimating the degree of humidity inside the fuel cell stack 2 based on the atmospheric pressure and the impedance of the fuel cell stack 2, and can therefore start the increase rate limitation process at a timing according to the internal state of the fuel cell stack 2 at that time.

(6) The ECU 6 ends the increase rate limitation process and the upper limit limitation process when the degree of humidity is maintained at or above a predetermined release threshold for a predetermined period of time or longer until the limit time reaches the setting time. Therefore, according to the present invention, the limitation on the output current can be released as the degree of humidity inside the fuel cell stack 2 is restored to a state suitable for power generation by the increase rate limitation process and the upper limit limitation process.

Although the embodiment of the present invention has been described above, the present invention is not limited thereto. The detailed configuration may be modified as appropriate within the spirit and scope of the present invention.

For example, in the dryness protection control described with reference to FIGS. 2A and 2B, the ECU 6 starts the increase rate limitation process as the number of high load cycles becomes equal to or more than the set number of times while the atmospheric pressure is less than the high altitude determination pressure, that is, while it is determined in step ST2 to be YES and the fuel cell stack 2 is determined to be in a high altitude environment where the inside thereof is prone to dryness, but the present invention is not limited thereto. The inside of the fuel cell stack 2 may become dry even when not in a high altitude environment. Therefore, the ECU 6 may start the increase rate limitation process as the number of high load cycles becomes equal to or more than the set number of times while the degree of humidity inside of the fuel cell stack 2 is less than a predetermined dryness determination threshold. Such dryness protection control can be implemented by determining whether the degree of humidity is less than the dryness determination threshold, instead of determining in step ST2 of FIG. 2A whether the atmospheric pressure is less than the high altitude determination pressure as described above.

What is claimed is:

1. A fuel cell system including a fuel cell that generates power when an anode gas and a cathode gas are supplied, the fuel cell system comprising:
an atmospheric pressure detector configured to detect an atmospheric pressure;
a current detector configured to detect an output current of the fuel cell;
a degree-of-humidity estimator configured to estimate a degree of humidity inside the fuel cell; and
an output controller configured to control output of the fuel cell,
the output controller being configured to execute:
a process of setting a current threshold for the output current to be a smaller value as the degree of humidity decreases;
a process of counting, as a number of high load cycles, a number of times a current detection value by the current detector becomes equal to or more than the current threshold; and
an increase rate limitation process of limiting an increase rate of the output current to a predetermined increase rate upper-limit value or less when the number of high load cycles becomes equal to or more than a set number of times set to 1 or more while the atmospheric pressure is less than a predetermined pressure.

2. The fuel cell system according to claim 1, wherein the output controller further executes:
a process of counting, as a limit time, a time elapsed from a start of the increase rate limitation process;
a process of setting a setting time, which is a threshold for the limit time, to be longer as the degree of humidity decreases; and
an upper limit limitation process of limiting the output current to be equal to or less than a current upper-limit value, which is set to a value smaller than the current threshold, as the current detection value becomes equal to or more than the current threshold until the limit time reaches the setting time.

3. The fuel cell system according to claim 2, wherein the output controller sets the increase rate upper-limit value to a smaller value as the degree of humidity decreases.

4. The fuel cell system according to claim 3, wherein the output controller reduces the current upper-limit value in steps every time the current detection value reaches the current upper-limit value.

5. The fuel cell system according to claim 2, further comprising an impedance acquirer configured to acquire impedance of the fuel cell, wherein
the degree-of-humidity estimator estimates the degree of humidity based on the atmospheric pressure and the impedance.

6. The fuel cell system according to claim 5, wherein the output controller ends the increase rate limitation process and the upper limit limitation process when the degree of humidity is maintained at or above a predetermined release threshold for a predetermined period of time or longer until the limit time reaches the setting time.

7. The fuel cell system according to claim 3, further comprising an impedance acquirer configured to acquire impedance of the fuel cell, wherein
the degree-of-humidity estimator estimates the degree of humidity based on the atmospheric pressure and the impedance.

8. The fuel cell system according to claim 7, wherein the output controller ends the increase rate limitation process and the upper limit limitation process when the degree of humidity is maintained at or above a predetermined release threshold for a predetermined period of time or longer until the limit time reaches the setting time.

9. The fuel cell system according to claim 4, further comprising an impedance acquirer configured to acquire impedance of the fuel cell, wherein
the degree-of-humidity estimator estimates the degree of humidity based on the atmospheric pressure and the impedance.

10. The fuel cell system according to claim 9, wherein the output controller ends the increase rate limitation process and the upper limit limitation process when the degree of humidity is maintained at or above a predetermined release threshold for a predetermined period of time or longer until the limit time reaches the setting time.

11. A control method of a fuel cell system including a fuel cell that generates power when an anode gas and a cathode gas are supplied, the control method comprising:
detecting an atmospheric pressure;
detecting an output current of the fuel cell;
estimating a degree of humidity inside the fuel cell;
setting a current threshold for the output current to be a smaller value as the degree of humidity decreases;
counting, as a number of high load cycles, a number of times a current detection value of the output current becomes equal to or more than the current threshold; and
executing an increase rate limitation process of limiting an increase rate of the output current to a predetermined increase rate upper-limit value or less when the number of high load cycles becomes equal to or more than a set number of times set to 1 or more while the atmospheric pressure is less than a predetermined pressure.

12. A fuel cell system including a fuel cell that generates power when an anode gas and a cathode gas are supplied, the fuel cell system comprising:
a current detector configured to detect an output current of the fuel cell;
a degree-of-humidity estimator configured to estimate a degree of humidity inside the fuel cell; and
an output controller configured to control output of the fuel cell,
the output controller being configured to execute:
a process of setting a current threshold for the output current to be a smaller value as the degree of humidity decreases;
a process of counting, as a number of high load cycles, a number of times a current detection value by the current detector becomes equal to or more than the current threshold; and
an increase rate limitation process of limiting an increase rate of the output current to a predetermined increase rate upper-limit value or less when the number of high load cycles becomes equal to or more than a set number of times set to 1 or more while the degree of humidity is less than a predetermined dryness determination threshold.

13. The fuel cell system according to claim 12, further comprising:
an atmospheric pressure detector configured to detect an atmospheric pressure; and
an impedance acquirer configured to acquire impedance of the fuel cell, wherein
the degree-of-humidity estimator estimates the degree of humidity based on the atmospheric pressure and the impedance.
